(19) United States
(12) Patent Application Publication
(10) Pub. No.: US 2007/0018962 A1
(43) Pub. Date: Jan. 25, 2007

(54) Message doll and message doll set

(76) Inventor: Isamu Takahashi, TOKYO (JP)

Correspondence Address: STAAS & HALSEY LLP, SUITE 700, 1201 NEW YORK AVENUE, N.W., WASHINGTON, DC, 20005, US

(21) Appl. No.: 10/538,493

(22) PCT Filed: Dec. 16, 2003
(86) PCT No.: PCT/JP03/16121

§ 371 Date: Jun. 9, 2005

(30) Foreign Application Priority Data
Dec. 17, 2002 (JP) 2002-365062

(51) Int. Cl. G09G 5/00

(52) U.S. Cl. 345/173

(57) ABSTRACT

There is provided a message figure which is easy to produce and is not required to have a mechanism for moving an erasing magnet on a back side of a magnetic display sheet and to secure a space for moving the erasing magnet. Attached to a figure (5) is a magnetic display sheet (6) which includes a plurality of microcapsules encapsulating oily liquid, light-absorbing ferromagnetic powder, light-reflecting nonmagnetic powder and anti-settling agent, and is adapted for making a drawing or a writing of a character and the like from a front side of the magnetic display sheet by using a drawing tool (3) having a magnet, and for erasing the drawing or the writing from the front side of the magnetic display sheet by using an erasing tool (4) having a magnet.

### TECHNICAL FIELD

The present invention relates to a figure and a figure set, and, more particularly, to a figure and a figure set which are adapted for use in delivering a message and the like.

### BACKGROUND ART

There has been known a magnetic display sheet which contains a plurality of microcapsules encapsulating light-absorbing ferromagnetic powder and light-reflecting nonmagnetic powder which are suspended in oily liquid (for example, see JP-Tokukai-2000-118189-A). Here, anti-settling agent is added into the oily liquid. The magnetic display sheet is adapted for making a drawing and a writing of such as a character from the front side of the magnetic display sheet by using a drawing tool having a magnet, and for erasing the drawing and the writing from the back side of the magnetic display sheet by using an erasing tool having a magnet.

With the magnetic display sheet, when the surface of the magnetic display sheet is rubbed with the drawing tool, the light-absorbing ferromagnetic powder in the microcapsules at the rubbed portion is attracted toward the uppermost position of the microcapsules, to form a drawing or writing along the rubbed portion on the front side of the magnetic display sheet. Further, with the drawing or writing being formed on the front side of the magnetic display sheet, when the back surface of the magnetic display sheet is rubbed with the erasing tool, the light-absorbing ferromagnetic powder in the microcapsules at the rubbed portion is attracted toward the lowermost position of the microcapsules, to erase along the rubbed portion the drawing or writing on the front side of the magnetic display sheet.

There are sold in the United Kingdom message figures each provided, on the belly portion thereof, with a magnetic display sheet and an erasing tool which are constituted as described above, and message figure sets each further provided with a drawing tool (for example, see TOMY U. K. Catalogue 2002).

However, in such message figures, there are required a mechanism for moving the erasing magnet at the back side of the magnetic display sheet and to secure a space for moving the erasing magnet.

The present invention has been made in view of the above problem, and an object thereof is to provide a message figure and a message figure set which are easily manufactured.

### DISCLOSURE OF THE INVENTION

To attain the above object, the inventor of the present invention and the like have made study on the microcapsule of the magnetic display sheet, and found out: that the viscosity of the oily liquid and the amount of the anti-settling agent are factors for determining the behavior of the light-absorbing ferromagnetic powder according to the magnetic force and the settling time of the powder; and that, not to speak of the front-drawing, the front-erasing becomes available by reducing the viscosity of the oily liquid and/or reducing the amount of the anti-settling agent. Further, it is found out that, to perform the front-erasing, it is effective to move the erasing magnet with the magnet kept separated from the surface of the magnetic display sheet (with a clearance kept formed between the surface of the magnetic display sheet and the erasing magnet).

The present invention has been made based on the above knowledge, and, according to a first aspect of the invention, a message figure comprises: a magnetic display sheet which includes a plurality of microcapsules encapsulating oily liquid, light-absorbing ferromagnetic powder, light-reflecting nonmagnetic powder and anti-settling agent, and is adapted for making a drawing or a writing of a character and the like from a front side of the magnetic display sheet by using a drawing tool having a magnet, and for erasing the drawing or the writing from the front side of the magnetic display sheet by using an erasing tool having a magnet, the magnetic display sheet being attached to the figure.

According to the message figure of the first aspect of the invention, it is possible to create a message by making a drawing or a writing of a character and the like from the front side of the magnetic display sheet with the drawing tool, and to erase the message which is not necessary any more from the front side of the magnetic display sheet with the erasing tool. Therefore, a mechanism and a space for moving the erasing magnet at the back side of the magnetic display sheet are not required, unlike the message figures of earlier development. As a result, it is possible to decrease the manufacturing steps and to reduce the cost therefor.

Preferably, in the message figure according to the first aspect of the invention, the magnetic display sheet constitutes part of an outline of the figure. Here, the “outline” includes not only the body of the figure but also the clothing thereof. This also applies to the description below.

With the message figures of earlier development, it is necessary to move the magnet such that the magnet rubs the back surface of the magnetic display sheet in order to erase the drawing or writing of a character and the like formed on the magnetic display sheet. Therefore, by stretchedly disposing the magnetic display sheet in a frame member, the magnetic display sheet is configured to have the back surface thereof to be a plane surface. In contrast, with the magnetic display sheet adapted for front-erasing, such condition is not required. Therefore, it is possible to constitute part of the outline of the figure with the magnetic display sheet, as in the case of the above message figure.

As a result, since the appearance of the figure is not damaged, it is possible to realize a highly charming message figure.

According to a second aspect of the invention, a message figure set comprises: a figure to which attached is a magnetic display sheet which includes a plurality of microcapsules encapsulating oily liquid, light-absorbing ferromagnetic powder, light-reflecting nonmagnetic powder and anti-settling agent, the magnetic display sheet being adapted for front-drawing and front-erasing; a drawing tool which includes a magnet and is adapted for making a drawing or a writing of a character and the like from a front side of the magnetic display sheet; and an erasing tool which includes a magnet and is adapted for erasing the drawing or the writing from the front side of the magnetic display sheet.

According to the message figure set of the second aspect of the invention, it is possible to create a message by making a drawing or a writing of a character and the like from the front side of the magnetic display sheet with the drawing tool, and to erase the message which is not necessary any more from the front side of the magnetic display sheet with the erasing tool. Therefore, a mechanism and a space for moving the erasing magnet at the back side of the magnetic display sheet are not required, unlike the message figures of earlier development. As a result, it is possible to decrease the manufacturing steps and to reduce the cost therefor.

Preferably, in the message figure set of the second aspect of the invention, the magnetic display sheet constitutes part of an outline of the figure.

According to the message figure set, since the magnetic display sheet constitutes part of the outline of the figure, it is possible to realize a highly charming message figure, without damaging the appearance of the figure.

Preferably, in the message figure set of the second aspect of the invention, the erasing tool includes a rubbing portion to rub a surface of the magnetic display sheet upon the erasing, and the rubbing portion is configured such that the magnet for the erasing is separated from the surface of the magnetic display sheet by a predetermined distance upon the erasing.

According to the message figure set, it is possible to easily erase the drawing or the writing by rubbing the surface of the magnetic display sheet with the rubbing portion.

Preferably, in the message figure set of the second aspect of the invention, the drawing tool and the erasing tool are integrated to form a pen shape as a whole.

According to the message figure set, since the drawing tool and the erasing tool are integrated to form a pen shape as a whole, the handling thereof is easy.

Preferably, in the message figure set of the second aspect of the invention, N and S poles of the magnet for the erasing are placed along the surface of the magnet display sheet upon the erasing.

According to the message figure set, N and S poles of the magnet for the erasing are placed along the surface of the magnet display sheet upon the erasing. Therefore, the erasing of the drawing or the writing is easy.

### BRIEF DESCRIPTION OF THE DRAWINGS

FIG. 1 is a perspective view of a message figure set according to a first embodiment of the present invention.

FIG. 2 is a sectional view of a magnetic display sheet of the message figure set shown in FIG. 1.

FIG. 3 is a sectional view of stationery of the message figure set shown in FIG. 1.

FIG. 4 is a sectional view for explaining operation of an erasing magnet of the message figure set shown in FIG. 1.

FIGS. 5A and 5B are front views showing behavior of light-absorbing ferromagnetic powder in microcapsules of the message figure set shown in FIG. 1.

FIG. 6 is a perspective view of a message figure set according to a second embodiment of the present invention.

FIG. 7 is a sectional view of a drawing tool of the message figure set shown in FIG. 6.

FIG. 8 is a sectional view of an erasing tool of the message figure set shown in FIG. 6.

### BEST MODES FOR CARRYING OUT THE INVENTION

### First Embodiment

1. Entire Structure

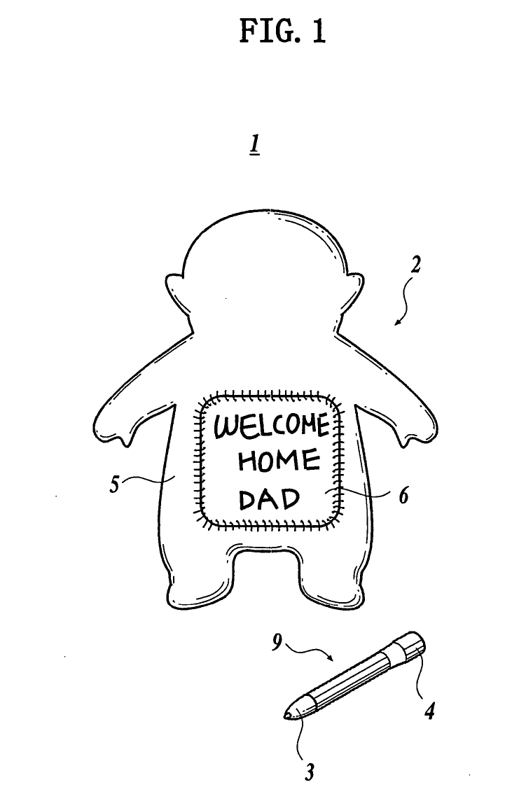

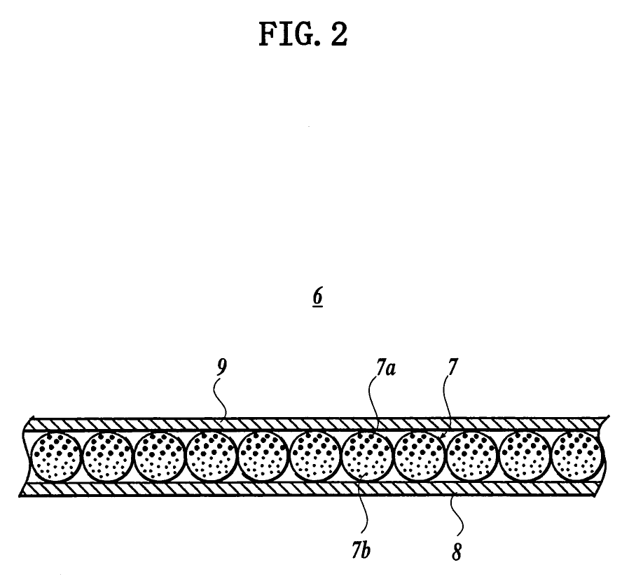

A message figure set 1 of a first embodiment includes a message FIG. 2, a drawing tool 3 and an erasing tool 4, as shown in FIG. 1. In the message figure set 1, a frameless magnetic display sheet 6 adapted for front-drawing and front-erasing is attached as it is to a belly portion of a doll 5. The drawing tool 3 and erasing tool 4 are integrated to constitute stationery 9 shaped like a pen as a whole.

2. Detail Structure

(1) Message FIG. 2

The message FIG. 2 is formed by attaching the magnetic display sheet 6 to the doll 5. The doll 5 may be a stuffed animal, or may be made of wood, plastic or synthetic resin.

Here, the message FIG. 2 is placed on a desk or the like in a state of being reclined against a wall. However, the message FIG. 2 may be, for example, adapted for placing on a desk or the like without being reclined against a wall, or hung on a wall or the like.

(2) Magnetic Display Sheet 6

The magnetic display sheet 6 includes, as shown in FIG. 2, a plurality of microcapsules 7 encapsulating light-absorbing ferromagnetic powder 7a and light-reflecting nonmagnetic powder 7b suspended in oily liquid. In the microcapsules 7, anti-settling agent is also encapsulated. The plurality of microcapsules 7 are sandwiched between protection sheets 8 and 9. The end portions of the protection sheets 8 and 9 are bonded to each other by high-frequency welder or the like. The protection sheet 9, which is disposed on the upper side, has a light-transmitting property.

With respect to the magnetic display sheet 6, the viscosity of the oily liquid and the amount of the anti-settling agent, and the like are adjusted so that the front-drawing and front-erasing are available. For example, the viscosity of the oily liquid is reduced and the amount of the anti-settling agent is decreased as compared with a magnetic display sheet of earlier development which is adapted for front-drawing and back-erasing. Such adjustment permits the magnetic powder (light-absorbing ferromagnetic powder 7a) in the microcapsules 7 to be evenly spread in the capsules. It is also permitted to prevent the light-absorbing ferromagnetic powder from being attracted toward the uppermost position in the microcapsules 7.

(3) Stationery 9

\textcircled{1} Drawing Tool 3

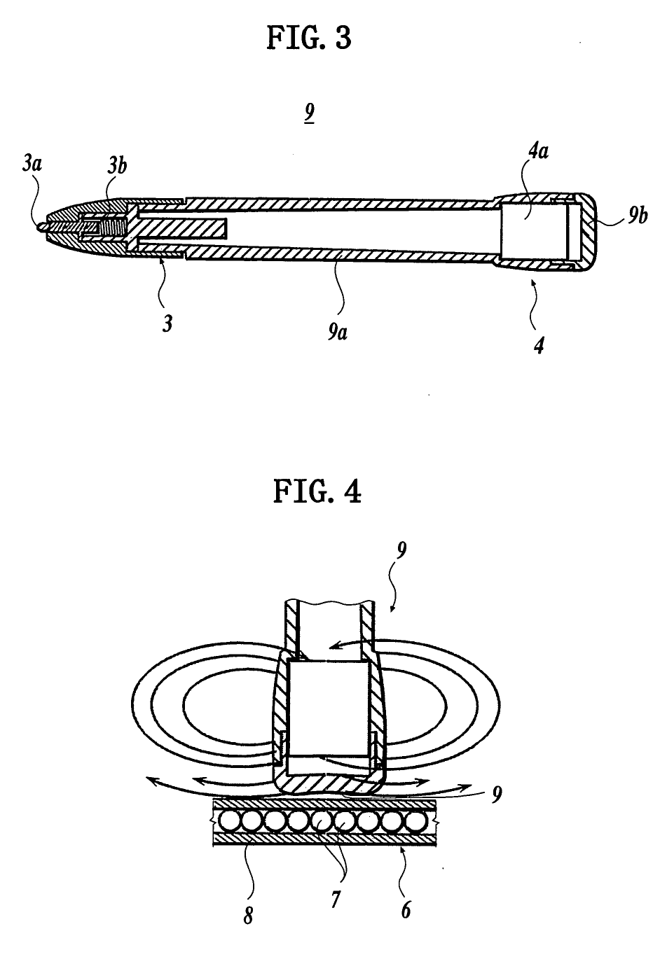

As shown in FIG. 3, the drawing tool 3 includes a core member 3a as a magnet for drawing. Although not particularly limited, for such magnet, there may be used a neodymium-based magnet made of an alloy of neodymium, iron and boron, a magnet made of an alloy of a rare-earth element called samarium and cobalt, a rare-earth magnet using praseodymium, and the like. By forming the core member 3a with such magnet, it becomes possible to clearly display even a thin line.

The core member 3a is biased in the direction of the top of the pen by a spring 3b.

\textcircled{2} Erasing Tool 4

The erasing tool 4 includes a cylindrical-shaped magnet 4a. The magnet 4a is disposed at a bottom end portion of a shaft 9a. A cover 9b is attached to the bottom end of the shaft 9a, such that the magnet 4a is not exposed. The cover 9b is used to rub the surface of the magnetic display sheet 6 for erasing a drawing or writing made thereon. Upon the erasing, the cover 9b serves to separate the magnet 4a from the surface of the magnetic display sheet 6 by a predetermined distance. The reason for constituting the erasing tool as mentioned above is as follows.

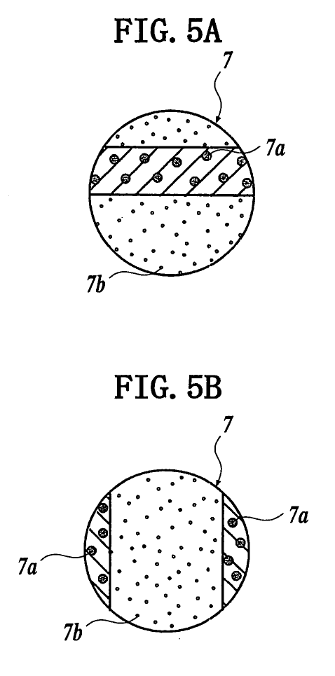

As shown in FIG. 4, to erase a drawing or writing made on the front side of the magnetic display sheet 6, lines of magnetic force along the surface of the magnetic display sheet 6 are effective, as compared with lines of magnetic force oriented to intersect the surface of the magnetic display sheet 6. In other words, as shown in FIG. 5 (a), the light-absorbing ferromagnetic powder 7a which has moved to a predetermined upper position (not the uppermost position) to constitute a layer forming a drawing or writing is moved to the right and left sides in the microcapsules 7, as shown in FIG. 5 (b). Thus, when viewed from the front side of the magnetic display sheet 6, the drawing is erased.

3. Mode of Use

(1) To Use as a Message Board

A person to deliver a message writes the message on the magnetic display sheet 6 by using the drawing tool 3. A person to receive the message erases the message by using the magnetic erasing tool 4, after reading the message.

(2) To Use as a Schedule

A plan for tomorrow or the like is written on the magnetic play sheet 6 by using the drawing tool 3. When the message is not necessary any more, the message is erased by using the magnetic erasing tool 4.

4. Advantageous Effects

A mechanism or a space for moving the erasing magnet are not required to be secured on the back side of the magnetic display sheet 6, unlike the message figures of earlier development. As a result, the manufacturing steps decrease and the cost therefor can be reduced.

Moreover, since the magnetic display sheet 6 constitutes part of the outline of the doll, it is possible to realize a highly charming message figure without damaging the appearance of the doll 5.

### Second Embodiment

1. Entire Structure

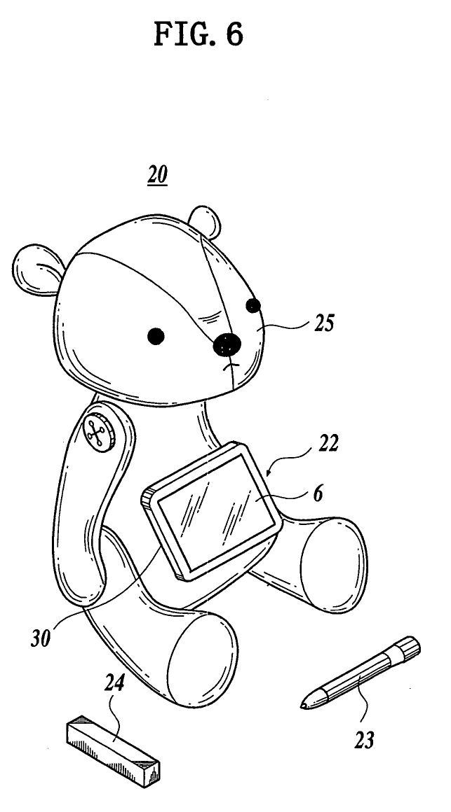

A message figure set 20 of a second embodiment includes a message FIG. 22, a drawing tool 23 and an erasing tool 24, as shown in FIG. 6. The message figure set 20 is different from that of the first embodiment in the following points; firstly, the display sheet 6 is held by a frame member 30; and, secondly, the drawing tool 23 and erasing tool 24 are separate from each other. Hereinbelow, a description will be made mainly of differences from the first embodiment. The same reference numerals are assigned in the drawings to the same elements as those of the first embodiment, and the description thereof is omitted.

2. Detail Structure

(1) Message FIG. 22

The message FIG. 22 is adapted for placing on a desk or the like in a sitting state.

Here, the message FIG. 22 may be attached on a base panel. In this case, since the message FIG. 22 is supported on the base panel, the message FIG. 22 can be placed in a stable state. Moreover, attaching the message FIG. 22 on the base panel makes it possible to increase a degree of freedom of forming the postures of a doll 25. For example, it is possible to lay down the doll 25.

The doll 25 may be a stuffed animal, or made of wood, plastic or synthetic resin, as in the case of the first embodiment.

(2) Magnetic Display Sheet 6

The frame member 30 is attached to the peripheral portion of the magnetic display sheet 6. The frame member 30 allows the magnetic display sheet 6 to be stretchedly disposed.

(3) Drawing Tool 23

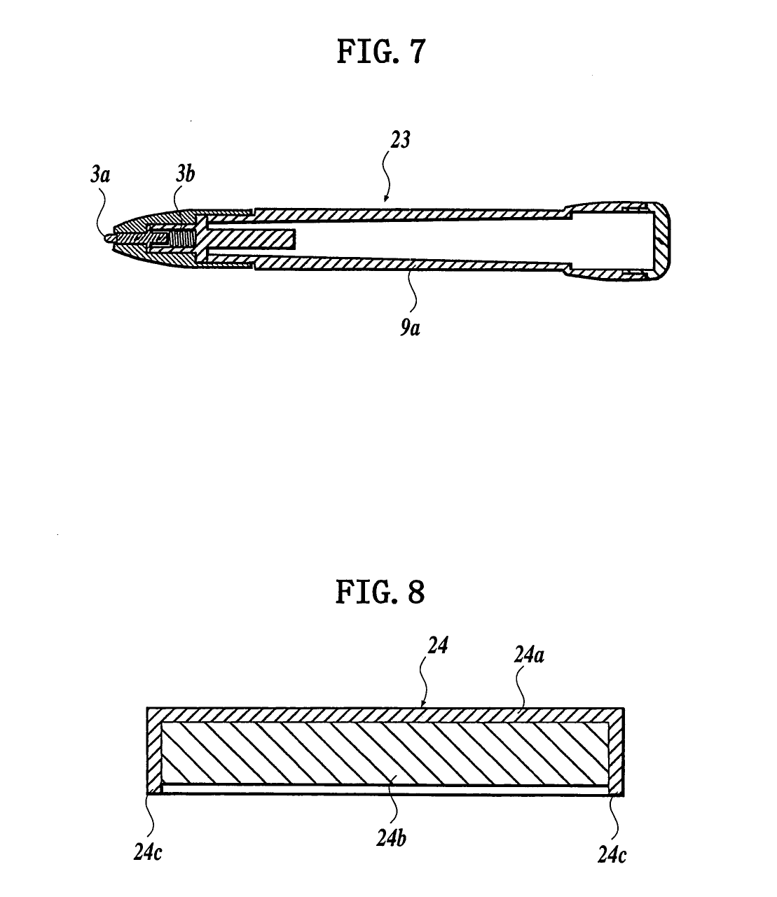

The drawing tool 23 is shaped like a pen, as shown in FIG. 7. Removing the erasing magnet 4a from the stationery 9 of the first embodiment forms the structure of the drawing tool 23.

(4) Erasing Tool 24

The erasing tool 24 has a structure in which a magnet 24b is fitted into an open-bottomed cuboid box member 24a, as shown in FIG. 8. The magnet 24b is stick-shaped and N and S poles thereof are placed in the longitudinal direction of the box member 24a. The magnet 24b is disposed in the box member 24a to form a recess therein. In other words, peripheral portions 24c of the box member 24b constitute rubbing portions, and serve to separate the magnet 24b from the surface of the magnetic display sheet 6 by a predetermined distance, upon erasing.

3. Advantageous Effects

A mechanism or a space for moving the erasing magnet are not required to be secured on the back side of the magnetic display sheet 6, unlike the message figures of earlier development. As a result, the manufacturing steps decrease and the cost therefor can be reduced.

Moreover, since the S and N poles of the erasing tool 24 are placed along the surface of the magnetic display sheet 6 upon erasing, it is possible to effectively use the lines of magnetic force along the surface of the magnetic display sheet 6.

4. Modification

Hereinabove, embodiments of the present invention have been described. The present invention, however, is not limited to the above embodiments. It goes without saying that various modifications can be made without departing from spirit and scope of the invention.

For example, in the first embodiment, the cylindrical-shaped magnet 4a is used as the erasing magnet. However, more preferably, a magnet having a large diameter relative to the thickness thereof may be used, in order to effectively utilize the lines of magnetic force acting along the surface of the magnetic display sheet 6.

### INDUSTRIAL APPLICABILITY

To describe advantageous effect of a representative embodiment of the present invention, there is comprised: a magnetic display sheet which includes a plurality of microcapsules encapsulating oily liquid, light-absorbing ferromagnetic powder, light-reflecting nonmagnetic powder and anti-settling agent, and is adapted for making a drawing or a writing of a character and the like from a front side of the magnetic display sheet by using a drawing tool having a magnet, and for erasing the drawing or the writing from the front side of the magnetic display sheet by using an erasing tool having a magnet, the magnetic display sheet being attached to the figure; therefore, it is possible to decrease the manufacturing steps and to reduce the cost therefor.

1. A message figure comprising: a magnetic display sheet which includes a plurality of microcapsules encapsulating oily liquid, light-absorbing ferromagnetic powder, light-reflecting nonmagnetic powder and anti-settling agent, and is adapted for making a drawing or a writing of a character and the like from a front side of the magnetic display sheet by using a drawing tool having a magnet, and for erasing the drawing or the writing from the front side of the magnetic display sheet by using an erasing tool having a magnet, the magnetic display sheet being attached to the figure.

2. The message figure as claimed in claim 1, wherein the magnetic display sheet constitutes part of an outline of the figure.

3. A message figure set comprising: a figure to which attached is a magnetic display sheet which includes a plurality of microcapsules encapsulating oily liquid, light-absorbing ferromagnetic powder, light-reflecting nonmagnetic powder and anti-settling agent, the magnetic display sheet being adapted for front-drawing and front-erasing; a drawing tool which includes a magnet and is adapted for making a drawing or a writing of a character and the like from a front side of the magnetic display sheet; and an erasing tool which includes a magnet and is adapted for erasing the drawing or the writing from the front side of the magnetic display sheet.

4. The message figure set as claimed in claim 3, wherein the magnetic display sheet constitutes part of an outline of the figure.

5. The message figure set as claimed in claim 3, wherein the erasing tool includes a rubbing portion to rub a surface of the magnetic display sheet upon the erasing, and the rubbing portion is configured such that the magnet for the erasing is separated from the surface of the magnetic display sheet by a predetermined distance upon the erasing.

6. The message figure set as claimed in claim 3, wherein the drawing tool and the erasing tool are integrated to form a pen shape as a whole.

7. The message figure set as claimed in claim 3, wherein N and S poles of the magnet for the erasing are placed along the surface of the magnet display sheet upon the erasing.

8. The message figure set as claimed in claim 4, wherein the erasing tool includes a rubbing portion to run a surface of the magnetic display sheet upon the erasing, and the rubbing portion is configured such that the magnet for the erasing is separated from the surface of the magnetic display sheet by a predetermined distance upon the erasing.

9. The message figure set as claimed in claim 4, wherein the drawing tool and the erasing tool are integrated to form a pen shape as a whole.

10. The message figure set as claimed in claim 5, wherein the drawing tool and the erasing tool are integrated to form a pen shape as a whole.

11. The message figure set as claimed in claim 4, wherein N and S poles of the magnet for the erasing are placed along the surface of the magnet display sheet upon the erasing.

12. The message figure set as claimed in claim 5, wherein N and S poles of the magnet for the erasing are placed along the surface of the magnet display sheet upon the erasing.

13. The message figure set as claimed in claim 6, wherein N and S poles of the magnet for the erasing are placed along the surface of the magnet display sheet upon the erasing.

14. The message figure set as claimed in claim 8, wherein N and S poles of the magnet for the erasing are placed along the surface of the magnet display sheet upon the erasing.

15. The message figure set as claimed in claim 9, wherein N and S poles of the magnet for the erasing are placed along the surface of the magnet display sheet upon the erasing.

16. The message figure set as claimed in claim 10, wherein N and S poles of the magnet for the erasing are placed along the surface of the magnet display sheet upon the erasing.
